(19) United States
(12) Patent Application Publication
(10) Pub. No.: US 2016/0153784 A1
(43) Pub. Date: Jun. 2, 2016

(54) MAP MARKING METHOD

(71) Applicants: Inventec (Pudong) Technology Corporation, Shanghai (CN); INVENTEC CORPORATION, Taipei (TW)

(72) Inventor: Li-Te Chen, Taipei (TW)

(21) Appl. No.: 14/688,330

(22) Filed: Apr. 16, 2015

(30) Foreign Application Priority Data
Nov. 27, 2014 (CN) 201410697220.4

(51) Int. Cl. G01C 21/00; G06F 17/30

(52) U.S. Cl. CPC G01C 21/00; G06F 17/30241

(57) ABSTRACT

A map marking method comprises capturing a map image from a physical map, capturing a plurality of reference coordinates corresponding to the physical map, obtaining a positioning coordinate from the global positioning system, calculating a positioning site on the physical map corresponding to the positioning coordinate according to the plurality of reference coordinates, the map image, and the positioning coordinate, and marking the positioning site on the physical map. As such, a user may arbitrarily mark his/her own position on a physical map with his/her positioning device utilizing the above mentioned method, and may explore the world more conveniently.

### CROSS-REFERENCE TO RELATED APPLICATIONS

This non-provisional application claims priority under 35 U.S.C. §119(a) on Patent Application No. 201410697220.4 filed in China on Nov. 27, 2014, the entire contents of which are hereby incorporated by reference.

### BACKGROUND OF THE INVENTION

1. Technical Field of the Invention

The present invention relates to a method for marking a map, particularly to a method for marking a current position of a user on a physical map.

2. Description of the Related Art

A navigation device is an electronic device for the path navigation and/or the direct navigation by combining global positioning system (GPS) signals and an electronic map, wherein direct navigation only labels the direction and the distance of the destination. The navigation device also displays the current position of the user on the map. However, due to the size of the monitor and the scale of the navigation device, the user often encounters the problem of not knowing his exact position on the map.

For example, when the map is displayed with an enlarged scale, although the surrounding environment is shown on the monitor, but the labels with farther distance are unable to be displayed within the scope of the monitor. It often happens when climbing a mountain. Mountaineers need to determine the climbing path according to the conditions of the mountain and a tiny lapse can lead to a huge difference. In addition, the built-in electronic map of the navigation device may not include the detailed information for mountain climbing, such as the hiking path the contour line, so the mountaineer usually needs to carry a professional map for mountain climbing.

The profession map for mountain climbing includes the labeled latitude and longitude coordinates. However, there are different systems for the latitude and longitude coordinate and the corresponding display formats are also different, such as degree/minute or degree/minute/second. Moreover, a more detailed graduation is not labeled on the map, such as millisecond or microsecond. Therefore, the user still has difficulties to know his position on the map even when the user obtains the geographic coordinate through the navigation device, the device capable of receiving GPS signals, or other device capable of calculating the geographic coordinate with wireless signals.

### SUMMARY OF THE INVENTION

A method for marking on a map by using an electronic device is provided. The method includes capturing a map image of a physical map, obtaining reference coordinates of a plurality of reference points on the physical map, obtaining a positioning coordinate of a current position of the electronic device, calculating a positioning site on the physical map corresponding to the positioning coordinate according to the reference coordinates, and marking the positioning site on the physical map.

In an embodiment, the plurality of reference coordinates include a first geographic coordinate on a first corner on the physical map and a second geographic coordinate on a second corner on the physical map, while the first corner and the second corner are located diagonally opposite to each other.

In an embodiment, the step of calculating the positioning site on the physical map according to the reference coordinates includes generating a map coordinate system according to the first geographic coordinate and the second geographic coordinate, calculating a coordinate site on the map coordinate system corresponding to the positioning coordinate, and using the coordinate site as the positioning site.

In an embodiment, the plurality of reference coordinates include a first geographic coordinate on a first corner of the physical map, a second geographic coordinate on a second corner of the physical map and a third geographic coordinate on a third corner of the physical map, while the first corner and the second corner are located diagonally opposite to each other.

In an embodiment, the step of calculating the positioning site on the physical map corresponding to the positioning coordinate according to the plurality of reference coordinates, the map image, and the positioning coordinate includes generating a coordinate transformation matrix according to the first geographic coordinate, the second geographic coordinate, the third geographic coordinate and the map image, and calculating the positioning site according to the coordinate transformation matrix and the positioning coordinate.

In an embodiment, the step of marking the positioning site includes (a) projecting a light beam onto the physical map such that a spot is generated on the physical map, (b) capturing a mark image from the physical map with the spot, (c) calculating a mark coordinate of the spot according to the mark image and the plurality of reference coordinates, (d) adjusting the projecting position of the light beam based on the calculated mark coordinate from step (c), and (e) repeating the steps from the step (b) to the step (d) until the mark coordinate equals to the positioning coordinate.

In an embodiment, the step of marking the positioning site includes (a) placing a mark corresponding to the positioning coordinate on the map image, and (b) projecting the map image having the mark onto the physical map, wherein the dimensions of the projected map image fits the dimensions of the physical map.

In an embodiment, the step of marking the positioning site includes displaying the part including the positioning site of the physical map on a display.

In an embodiment, the step of capturing the plurality of reference coordinates from the physical map includes executing an image recognition procedure on the map image to recognize a barcode block in the map image, and decoding the barcode block to obtain the plurality of reference coordinates.

In an embodiment, the step of capturing the plurality of reference coordinates from the physical map includes executing an image recognition procedure on the map image to recognize a plurality of latitude and longitude coordinate blocks in the map image, and executing a character recognition procedure to the plurality of latitude and longitude coordinate blocks to obtain the plurality of reference coordinates.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a flowchart of the method for marking on a map according to an embodiment of the present invention;

FIG. 2A is a diagram of the step S1100 according to an embodiment of the present invention;

FIG. 2B is a diagram of the captured map image in FIG. 2A;

FIG. 2C is a partial diagram of the tagged physical map after the step S1500 according to an embodiment of the present invention;

FIG. 3 is a flowchart of the step S1400 in FIG. 1 according to an embodiment of the present invention;

FIG. 4 is a diagram of the built map coordinate system according to an embodiment of the present invention;

FIG. 5 is a diagram of the working scenario of positioning device using the mark according to an embodiment of the present invention;

FIG. 6 is a flowchart of the step S1400 in FIG. 1 according to another embodiment of the present invention;

FIG. 7A is a diagram of the deformed map image according to an embodiment of the present invention;

FIG. 7B is a partial diagram of the normal map according to an embodiment of the present invention;

FIG. 8 is a flowchart of the step S1200 according to an embodiment of the present invention; and

FIG. 9 is a flowchart of the step S1200 according to another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An embodiment of the present invention is adapted for a device with global positioning system (GPS). For example, the device is but not limited to a navigation device, a positioning device, or a portable device with the GPS function, which includes an image capturing device, a processor and a marking device, such as a smart phone, a tablet, a notebook, or any portable device with arithmetic functions. The embodiment is for illustrating but not for limiting the present disclosure.

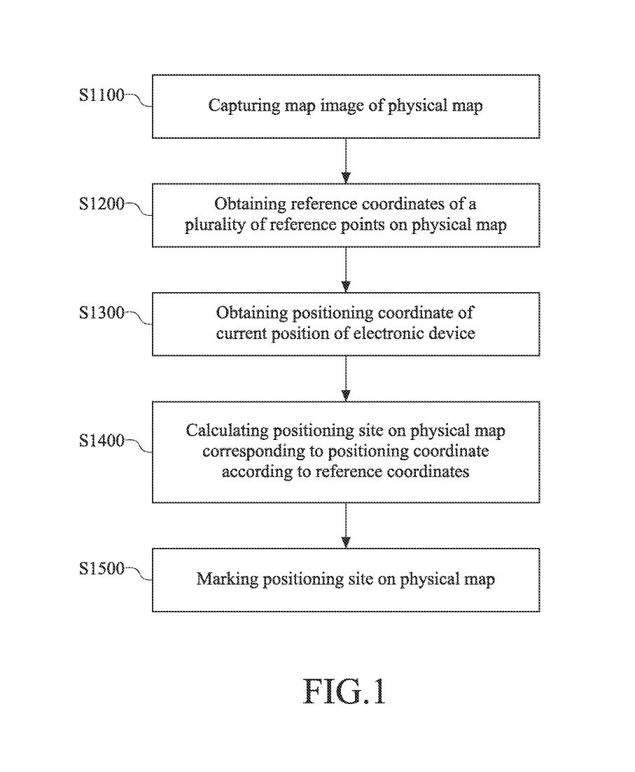

Please refer to FIG. 1. FIG. 1 is a flowchart of the method for marking on a map according to an embodiment of the present invention. As shown in FIG. 1, the method for marking on a map includes the following steps. As shown in the step S1100, a map image is captured from a physical map by the image capturing device. As shown in the step S1200, a plurality of reference coordinates are captured corresponding to the physical map. As shown in the step S1300, a positioning coordinate is obtained from the GPS. As shown in the step S1400, a positioning site in the physical map corresponding to the positioning coordinate is calculated by the processor according to the plurality of reference coordinates, the map image, and the positioning coordinate. As shown in the step S1500, the positioning site is tagged on the physical map.

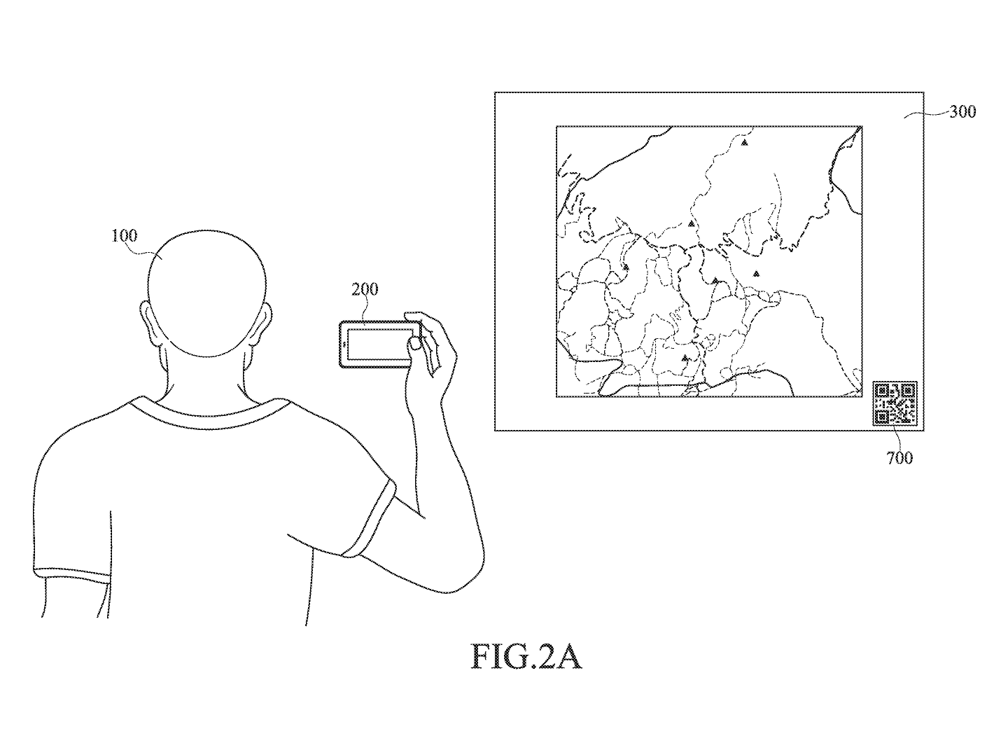

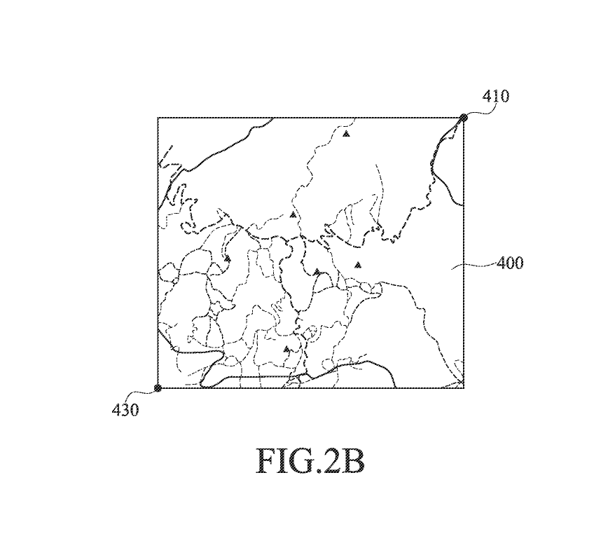

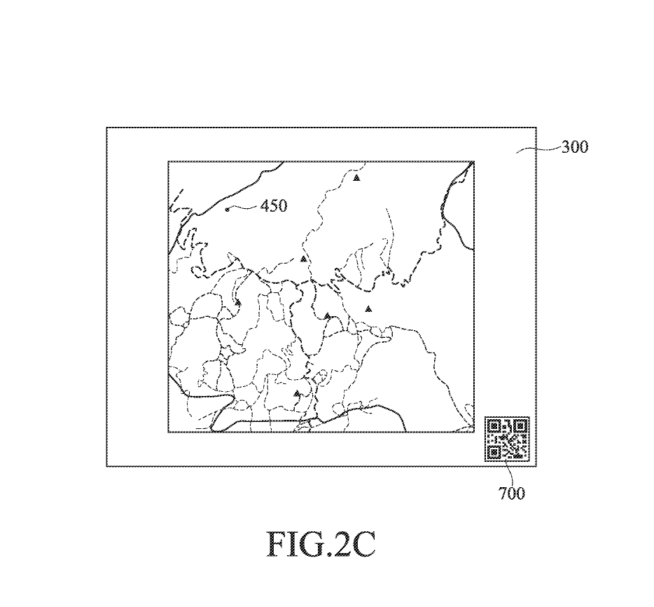

For example, please refer to FIG. 2A to FIG. 2C. FIG. 2A is a diagram of the step S1100 according to an embodiment of the present invention. FIG. 2B is a diagram of the captured map image in FIG. 2A. FIG. 2C is a partial diagram of the tagged physical map after the step S1500 according to an embodiment of the present invention. As shown in FIG. 2A, the user 100 uses the built-in image capturing module of the positioning device 200 to capture a map image from the physical map 300. The captured map image 400 is shown in FIG. 2B. The built-in processing module of the positioning device 200 obtains the reference coordinate 410 and the reference coordinate 430 from the map image 400, wherein a line defined by the two reference coordinates is a diagonal of the physical map 300/map image 400. In spite of the example of the two reference coordinates, however, the reference coordinates of the present embodiment include but not limited to the three reference coordinates of the three corners of the map image 400, the four reference coordinates of the four corners, or the reference coordinates of a plurality of famous landmarks. As shown in FIG. 2C, the positioning site on the physical map 300 and/or the positioning site in the map image 400 of the positioning coordinates obtained from the GPS are calculated and tagged according to the reference coordinate 410 and the reference coordinate 430.

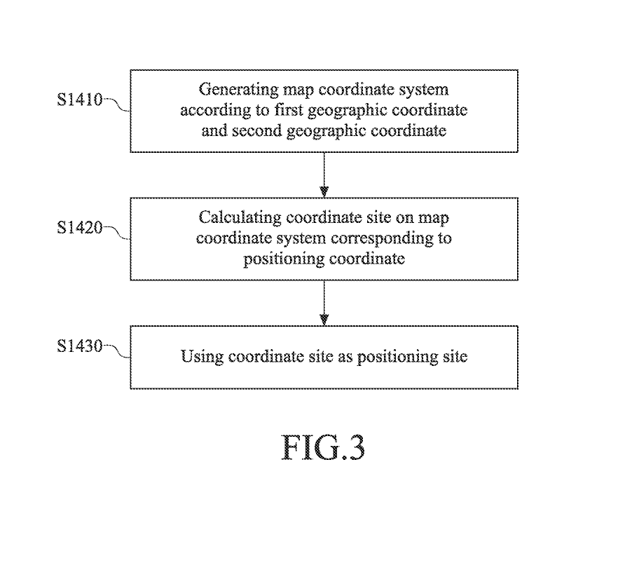

Referring to the implementation of the step S1400 in certain embodiments, please refer to FIG. 3. FIG. 3 is a flowchart of the step S1400 in FIG. 1 according to an embodiment of the present invention. As shown in FIG. 3, the step S1400 includes the following steps: as shown in the step S1410, a map coordinate system is created according to the first geographic coordinate and the second geographic coordinate. As shown in the step S1420, a coordinate site of the positioning coordinate in the map coordinate system is calculated. As shown in the step S1430, the coordinate site is used as the positioning site.

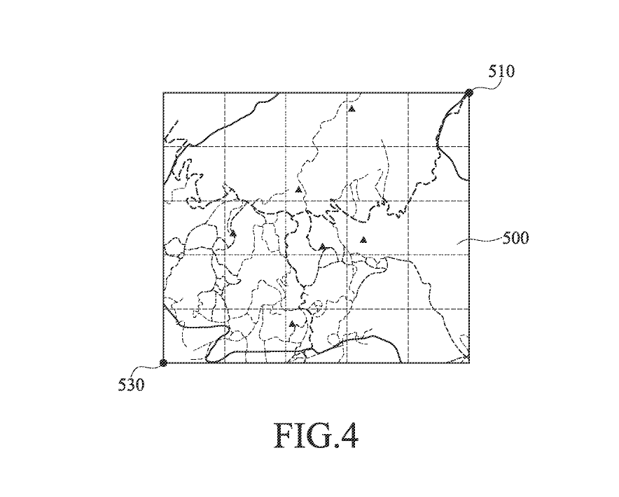

In association with the step S1410 to the step S1430, please refer to FIG. 2B, FIG. 2C, and FIG. 4 together. FIG. 4 is a diagram of the built map coordinate system according to an embodiment of the present invention. In FIG. 2B, the latitude and longitude coordinate corresponding to the reference coordinate 410 is (N 25°12′29″, E 121°38′54″) and the latitude and longitude coordinate corresponding to the reference coordinate 430 is (N 25°08′14″, E 121°30′10″) in the map image 400. Assuming that the map image 400 is a rectangle of 800×600 in resolution, namely, a standard map format, every pixel in the map image 400 corresponds to a geographic coordinate/latitude and longitude coordinate. According to the aforementioned coordinates, the built-in processing module of the positioning device 200 builds a map coordinate system 500 as shown in FIG. 4. In an embodiment, when building the map coordinate system 500, the map coordinate 510 corresponds to the reference coordinate 410 and the map coordinate 530 corresponds to the reference coordinate 430. The map coordinate 530 is defined as (0, 0) and the map coordinate 530 is defined as (800, 600). The latitude and longitude coordinate corresponds to every pixel (X, Y) in the map coordinate system 500 is calculated by the following equations and a database is built to store the latitude and longitude coordinate corresponds to every pixel (X, Y). The database is further stored in the memory unit of the positioning device 200 for query.

longitude=E 121°30′10″30 X*(E 121°38′54″-E 121°30′10″)/800

latitude=N 25°08′14″30 Y*(N 25°12′29″-N 25°08′14″)/600

Then the position of the positioning coordinate is found in the map coordinate system 500, that is, the position of the positioning coordinate is the coordinate site. Next, the coordinate site is taken as the positioning site and is tagged on the physical map 300, so that the correction of the tagged positioning site is determined with the map image 400.

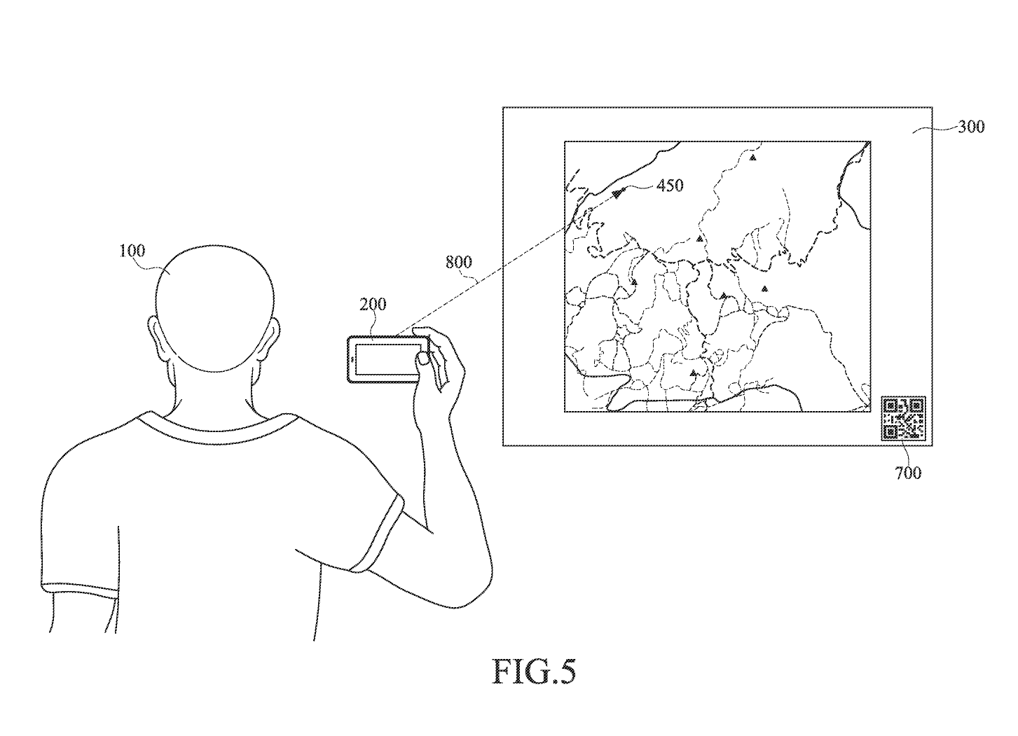

For example, please refer to FIG. 5. FIG. 5 is a diagram of the working scenario of positioning device using the mark according to an embodiment of the present invention. As shown in FIG. 5, when positioning, the positioning device 200 projects a light beam 800 onto the physical map 300. When the positioning device 200 captures the map image 400, the position of the tagged spot in the map image 400, namely, the mark position 450 is found. The processing module of the positioning device 200 calculates the latitude and longitude coordinate of the mark coordinate of the mark position 450 according to the map image 400, the latitude and longitude coordinate of the reference coordinate 410 and the latitude and longitude coordinate of the reference coordinate 430. In another embodiment, the latitude and longitude coordinate of the mark coordinate of the mark position 450 is directly obtained by querying the aforementioned database built in the memory unit. In addition, the processing module repeatedly adjusts the beaming direction of the light beam 800, so that the latitude and longitude coordinate of the mark position 450 eventually equals to the latitude and longitude coordinate of the positioning coordinate and the mark position 450 is the positioning site at this time.

In addition, in another embodiment, when the positioning device 200 has a display, the processing module of the positioning device 200 displays part of the map image corresponding to the positioning site in the display. Therefore, the user 100 determines his position corresponding to the physical map 300 by watching the monitor.

Moreover, in a further embodiment, the positioning device 200 tags the corresponding positioning coordinate on the captured map image and projects the tagged map image onto the physical map 300, so that the size and the shape of the projected map image fits the physical map 300. Therefore, marking and projecting the map image onto the physical map helps the user 100 to know his exact position and area on the physical map 300.

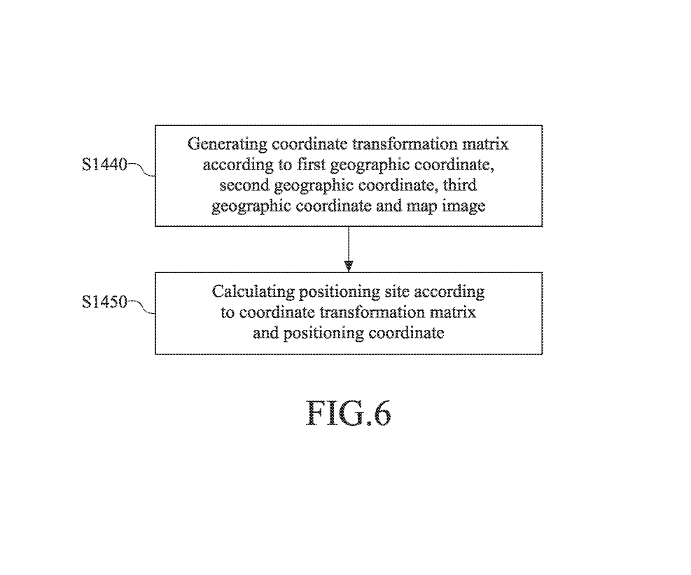

In association with the implementation of the step S1400 in another embodiment of the present invention, please refer to FIG. 6. FIG. 6 is a flowchart of the step S1400 in FIG. 1 according to another embodiment of the present invention. As shown in FIG. 6, the step S1400 includes the following steps: as shown in the step S1440, a coordinate transformation matrix is generated according to the first geographic coordinate, the second geographic coordinate, the third geographic coordinate and the map image. As shown in the step S1450, the positioning site is calculated according to the coordinate transformation matrix and the positioning coordinate.

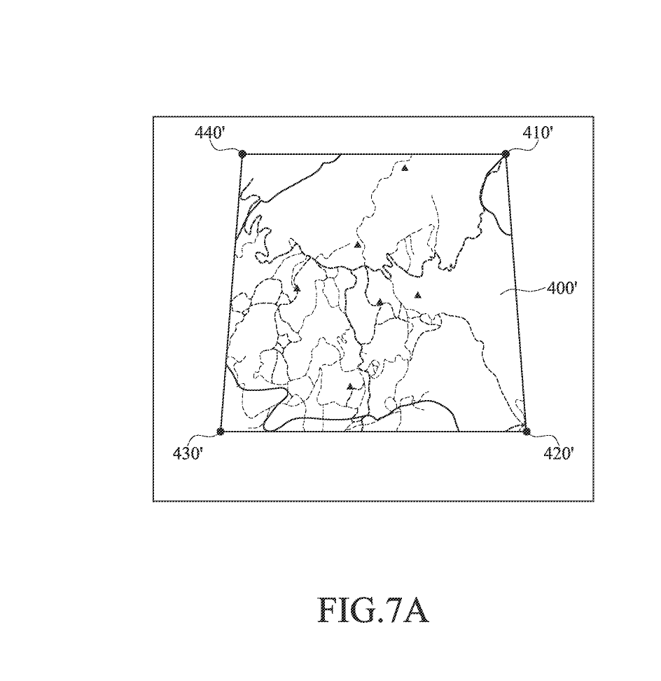

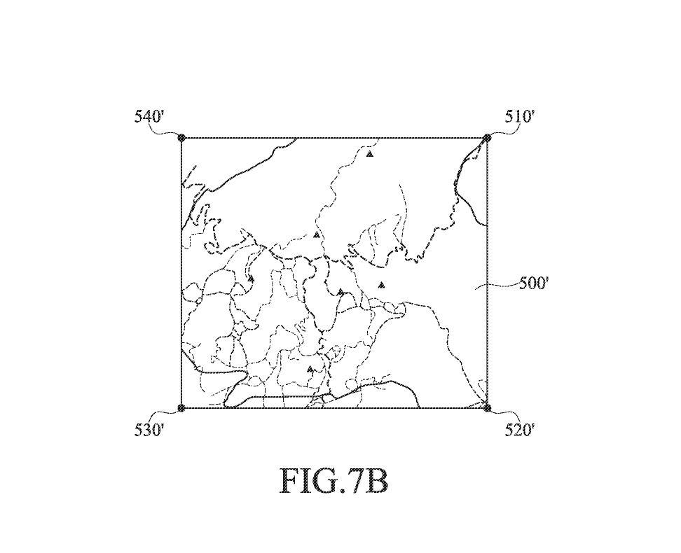

Specifically, please refer to FIG. 7A and FIG. 7B. FIG. 7A is a diagram of the deformed map image according to an embodiment of the present invention. FIG. 7B is a partial diagram of the normal map according to an embodiment of the present invention. As shown in FIG. 7A, the map image 400′ includes a reference coordinate 410′, a reference coordinate 420′, a reference coordinate 430′, and a reference coordinate 440′. The map image 400′ is an image of 800×600 in resolution and every pixel in the image is deemed a coordinate point. For example, the coordinate point of lower left corner in the image is (1,1), and the coordinate point of upper right corner in the image is (800,600), and therefore the pixel coordinates corresponding to the reference coordinate 410′ to 440′ in the image are (700,500), (790,100), (10,100), and (100,500) respectively. Meanwhile, assuming that the pixels of the reference coordinates 510′ to 540′ on the normal map 500′ corresponding to the reference coordinates 410′ to 440′ are (800,600), (800,1), (1,1), and (1,600). Therefore, a coordinate transformation matrix is obtained according to the pixel coordinates corresponding to the four reference coordinates. According to the obtained coordinate transformation matrix, the positioning sites adapted for the map image 400′ are converted from the positioning coordinates.

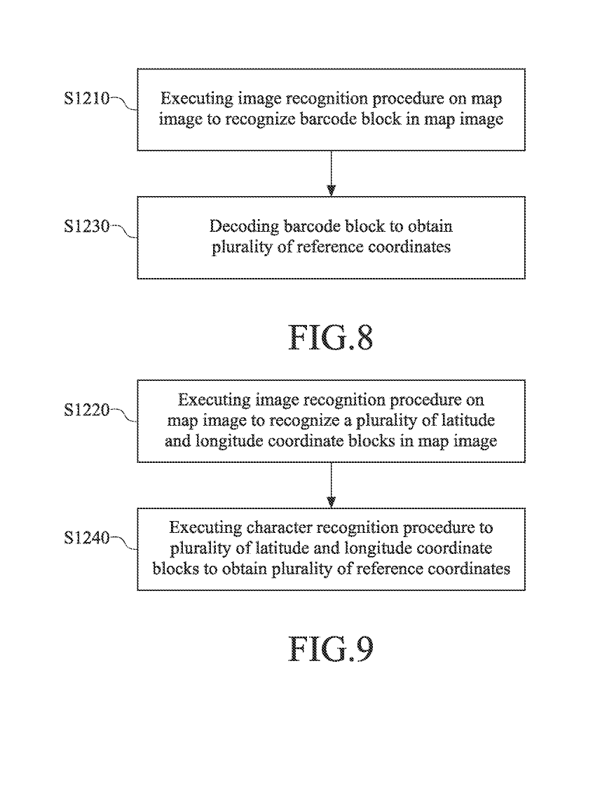

In another embodiment of the present invention, referring to the detailed implementation of the step S1200, please refer to FIG. 8. FIG. 8 is a flowchart of the step S1200 according to an embodiment of the present invention. As shown in FIG. 8, the step S1200 includes the following steps: as shown in the step S1210, an image recognition procedure is executed to the map image to recognize a barcode block in the map image, such as the two-dimensional barcode 700 in FIG. 2A. As shown in the step S1230, the barcode block is decoded to obtain the plurality of reference coordinates.

In other words, the data related to the reference coordinates in the map image are digitized and displayed with the barcode block. For example, the barcode of the barcode block is but not limited to one-dimensional barcode, two-dimensional barcode, high capacity color barcode, or other barcode adapted for being scanned to display information. The one-dimensional barcode is but not limited to Code⇄and Modified Plessey. The two-dimensional barcode is but not limited to quick response code (QR code), Chinese-sensible code, data matrix, and PDF 417 barcode. Referring to the reference coordinates in the stored map image, the following is an example for explaining the details. When the reference coordinates are located on the four corners of the map image, namely, the reference coordinate 410′ to the reference coordinate 440′ in FIG. 4A, the storage format of the reference coordinate is shown as Table 1. The information ┌11┘ indicates that the reference coordinate is located on the upper right corner, and the information ┌10┘ indicates that the reference coordinate is located on the lower right corner, and the information ┌00┘ indicates that the reference coordinate is located on the lower left corner, and the information ┌01┘ indicates that the reference coordinate is located on the upper left corner. However, Table 1 is only an example. The storage format of the barcode block is not limited to the previous explanation and can be designed according to the need of the designer.

TABLE 1

| | |
|---|---|
| 11 | (N 25°12′29″, E 121°38′54″) |
| 10 | (N 25°08′14″, E 121°38′54″) |
| 00 | (N 25°08′14″, E 121°30′10″) |
| 01 | (N 25°12′29″, E 121°30′10″) |

In another embodiment of the present invention, referring to the detailed implementation of the step S1200, please refer to FIG. 9. FIG. 9 is a flowchart of the step S1200 according to another embodiment of the present invention. As shown in FIG. 9, the step S1200 includes the following steps: as shown in the step S1220, an image recognition procedure is executed to the map image to recognize a plurality of latitude and longitude coordinate blocks in the map image. As shown in the step S1240, a character recognition procedure is executed to the plurality of latitude and longitude coordinate blocks to obtain the plurality of reference coordinates. The labeling method for the latitude and longitude coordinate is but not limited to the degree-minute-second format in the previous example or the format of degrees with decimal points. The character recognition procedure applies the techniques of image recognition and optical character recognition (OCR) and is not further explained hereinafter.

In summary, the positioning or navigation device applying the method illustrated in an embodiment of the present invention tags the current position with the physical map after the positioning coordinate and the image of the physical map are obtained. Therefore, the user uses the positioning device applying the method illustrated in an embodiment of the present invention to mark his current position with the physical map, so that the user is able to explore any kind of environment in a more convenient way.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A method for marking on a map by using an electronic device, comprising:
capturing a map image of a physical map;
obtaining reference coordinates of a plurality of reference points on the physical map;
obtaining a positioning coordinate of a current position of the electronic device;
calculating a positioning site on the physical map corresponding to the positioning coordinate according to the reference coordinates; and
marking the positioning site on the physical map.

2. The method of claim 1, wherein the plurality of reference coordinates comprise a first geographic coordinate on a first corner on the physical map and a second geographic coordinate on a second corner on the physical map, while the first corner and the second corner are located diagonally opposite to each other.

3. The method of claim 2, wherein the step of calculating the positioning site on the physical map according to the reference coordinates comprises:
generating a map coordinate system according to the first geographic coordinate and the second geographic coordinate;
calculating a coordinate site on the map coordinate system corresponding to the positioning coordinate; and
using the coordinate site as the positioning site.

4. The method of claim 1, wherein the plurality of reference coordinates comprise a first geographic coordinate on a first corner of the physical map, a second geographic coordinate on a second corner of the physical map and a third geographic coordinate on a third corner of the physical map, while the first corner and the second corner are located diagonally opposite to each other.

5. The method of claim 4, wherein the step of calculating the positioning site on the physical map corresponding to the positioning coordinate according to the plurality of reference coordinates, the map image, and the positioning coordinate comprises:
generating a coordinate transformation matrix according to the first geographic coordinate, the second geographic coordinate, the third geographic coordinate and the map image; and
calculating the positioning site according to the coordinate transformation matrix and the positioning coordinate.

6. The method of claim 1, wherein the step of marking the positioning site comprises:
(a) projecting a light beam onto the physical map such that a spot is generated on the physical map;
(b) capturing a mark image from the physical map with the spot;
(c) calculating a mark coordinate of the spot according to the mark image and the plurality of reference coordinates;
(d) adjusting the projecting position of the light beam based on the calculated mark coordinate from step (c); and
(e) repeating the steps from the step (b) to the step (d) until the mark coordinate equals to the positioning coordinate.

7. The method of claim 1, wherein the step of marking the positioning site comprises:
(a) placing a mark corresponding to the positioning coordinate on the map image; and
(b) projecting the map image having the mark onto the physical map, wherein the dimensions of the projected map image fits the dimensions of the physical map.

8. The method of claim 1, wherein the step of marking the positioning site comprises displaying the part including the positioning site of the physical map on a display.

9. The method of claim 1, wherein the step of capturing the plurality of reference coordinates from the physical map comprises:
executing an image recognition procedure on the map image to recognize a barcode block in the map image; and
decoding the barcode block to obtain the plurality of reference coordinates.

10. The method of claim 1, wherein the step of capturing the plurality of reference coordinates from the physical map comprises:
executing an image recognition procedure on the map image to recognize a plurality of latitude and longitude coordinate blocks in the map image; and
executing a character recognition procedure to the plurality of latitude and longitude coordinate blocks to obtain the plurality of reference coordinates.
